(19) United States
(12) Patent Application Publication
(10) Pub. No.: US 2012/0160705 A1
(43) Pub. Date: Jun. 28, 2012

(54) WATER TREATMENT METHOD AND SYSTEM

(75) Inventor: Valrie Dene Robinson, Delahey (AU)

(73) Assignee: AQUATECH WATER PURIFICATION SYSTEMS PTY LTD, Braeside, Victoria (AU)

(21) Appl. No.: 13/379,727

(22) PCT Filed: Jun. 22, 2010
(86) PCT No.: PCT/AU2010/000777

§ 371 Date: Mar. 16, 2012

Related U.S. Application Data
(60) Provisional application No. 61/219,834, filed on Jun. 24, 2009.

(51) Int. Cl. C02F 1/461; B23P 23/00; C25B 9/00

(52) U.S. Cl. 205/756; 205/755; 205/757; 204/273; 29/401.1

(57) ABSTRACT

A water treatment system includes a reservoir for holding water to be treated, one or more primary electrode pairs at least partially immersed in water held in the reservoir, a power supply adapted to power the one or more primary electrode pairs, and an agitator operable to cause movement in the water and particles and gases therein. Water is treated in the system by performing at least a first electrolysis phase wherein one or more of the primary electrode pairs are powered using electrical current of a first polarity such that for each powered primary electrode pair one electrode provides dissolved ions which act as an attractant for impurities to aid removal of the impurities from the water. The agitator can be operated during the first electrolysis phase to cause movement in the water and particles and gases therein to aid carriage of ions and impurities away from the electrodes.

### CROSS REFERENCE TO RELATED APPLICATION

This application is based on and claims the benefit of the filing date of US provisional patent application Ser. No. 61/219,834 filed 24 Jun. 2009, the contents of which is incorporated herein by reference in its entirety.

### FIELD OF THE INVENTION

The field of the invention is water treatment and in particular removal of impurities from water using electrolysis based methods.

### BACKGROUND OF THE INVENTION

Supply of clean water is vital for human and environmental health. As ready supplies of clean water become scarce or inadequate to meet human and environmental requirements, water purification becomes increasingly important. In particular the ability to remove impurities from polluted water to enable this water to be safely released into the environment or reused is a great value in industry and households.

Electrolysis based water purification methods are one known method for removal of impurities form water. Two known electrolysis based water purification methods are electroflocculation and electrocoagulation. Each of these methods are based on sacrificial electrodes being used to generate a coagulating agent in the form of ions which bond with water borne impurities. In electroflocculation bubbles released from the electrodes during electrolysis float the coagulated impurities to the surface of the water for removal. In electrocoagulation, the coagulated impurities are filtered from the water or allowed to settle once the water has been treated. There are significant known problems with both electroflocculation and electrocoagulation which limit the usefulness and commercial viability of these processes. A very significant problem is clogging of electrodes. Clogging is caused by the impurities bonding to the electrodes and coating the electrode. This clogging or fouling of the electrode causes the electrode to cease to pass current hence the purification process. Clogging leads to electrodes needing to be replaced before the metal has been fully sacrificed, causing significant increases in operation and maintenance costs.

### SUMMARY OF THE INVENTION

According to a first aspect of the present invention there is provided a water treatment method comprising the steps of:

providing water to be treated to a treatment apparatus comprising:
a reservoir for holding the water to be treated;
one or more primary electrode pairs positioned to be at least partially immersed in water held in the reservoir and connected to a power supply; and
a selectively operable agitator;

performing a first electrolysis phase wherein one or more of the primary electrode pairs are powered using an electrical current of a first polarity such that for each powered primary electrode pair one electrode provides dissolved ions which act as an attractant for impurities to aid removal of the impurities from the water;

operating the agitator during the first electrolysis phase to cause movement in the water and particles and gases therein to aid carriage of ions and impurities away from the electrodes; and

removing the impurities from the water.

In an embodiment the agitator is operated periodically during the first electrolysis phase.

In some embodiments the method further comprises the steps of
performing a second electrolysis phase during which one or more pairs of electrodes are powered using an electrical current having a reverse polarity to that of the first polarity; and

operating the agitator during the second electrolysis phase.

The agitator may be operated during a resting phase after the completion of the electrolysis phase.

According to another aspect of the present invention there is provided a water treatment system comprising

a reservoir for holding the water to be treated;

one or more primary electrode pairs positioned to be at least partially immersed in water held in the reservoir;

a power supply adapted to power the one or more primary electrode pairs to perform at least a first electrolysis phase wherein one or more of the primary electrode pairs are powered using an electrical current of a first polarity such that for each powered primary electrode pair one electrode provides dissolved ions which act as an attractant for impurities to aid removal of the impurities form the water; and

an agitator operable to cause movement in the water and particles and gases therein to aid carriage of ions and impurities away from the electrodes.

In an embodiment the system further comprises an agitator controller adapted to control operation of the agitator based on electrolysis phase.

In some embodiments the agitator works to move water within the reservoir. For example the agitator can be a pump. Alternatively the agitator can be a stirring mechanism.

In some alternative embodiments the agitator injects a gas into the reservoir. For example, the agitator can inject the gas into the reservoir from below the electrode pairs as a plurality of bubbles. For example, the agitator can includes a plurality of perforated pipes disposed within the reservoir below the primary electrode pairs through which the gas in injected. In an alternative example, the agitator includes one or more air stones disposed within the reservoir below the primary electrode pairs through which the gas in injected. In some embodiments the gas is air. In some embodiments the gas includes a proportion of ozone.

In some further alternative embodiments the agitator comprises one or more sets of secondary electrodes disposed below the primary electrode pairs and connected to a power supply whereby power supplied to the secondary electrodes causes production of bubbles within the water.

In an embodiment the system further comprises a controller adapted to monitor the cumulative charge applied during the first phase to power the electrode pairs and end the first phase by ceasing to power the electrodes when a cumulative charge threshold based on volume of water treated is reached.

In an embodiment the power supply is further adapted to power one or more pairs of electrodes during a second electrolysis phase using an electrical current having a reverse polarity to that of the first polarity.

According to another aspect of the invention there is provided a method of upgrading an electrolysis-based water treatment system comprising:

a reservoir for holding the water to be purified;

one or more primary electrode pairs positioned to be at least partially immersed in water held in the reservoir; and

a power supply adapted to power the one or more primary electrode pairs to perform at least a first electrolysis phase wherein one or more of the primary electrode pairs are powered using an electrical current of a first polarity such that for each powered primary electrode pair one electrode provides dissolved ions which act as an attractant for impurities to aid removal of the impurities form the water,

the method comprising the step of:

installing an agitator operable to cause movement in the water and particles and gases therein to aid carriage of ions and impurities away from the electrodes.

### BRIEF DESCRIPTION OF THE DRAWINGS

An embodiment, incorporating all aspects of the invention, will now be described by way of example only with reference to the accompanying drawings in which:

FIG. 1 is an example of a water treatment system according to one embodiment of the present invention

FIG. 2 is an illustrative example of a water treatment system according to an embodiment of the present invention

FIG. 3 is a flowchart of an example of a water treatment method according to an embodiment of the present invention

FIGS. 4a and 4b illustrate one advantageous arrangement of mismatched size anode and cathode pairs

FIGS. 5a and 5b illustrate an alternative arrangement of mismatched anode and cathode pairs

### DETAILED DESCRIPTION

Embodiments of the present invention provide a system and method for electrolysis based water treatment. The water treatment system comprises a reservoir for holding water to be treated; one or more primary electrode pairs positioned to be at least partially immersed in water held in the reservoir; a power supply adapted to power the one or more primary electrode pairs to perform at least a first electrolysis phase wherein one or more of the primary electrode pairs are powered using an electrical current of a first polarity such that for each powered primary electrode pair one electrode provides dissolved ions which act as an attractant for impurities to aid removal of the impurities form the water; and an agitator operable to cause movement in the water and particles and gases therein to aid carriage of ions and impurities away from the electrodes.

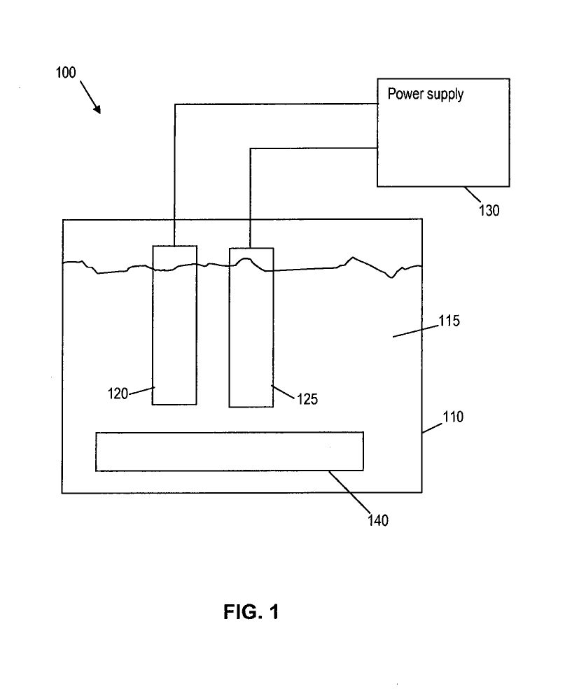

An example of water treatment system is illustrated in FIG. 1. The water treatment system 100 of FIG. 1 comprises a reservoir 110 for holding water 115 to be treated, one or more primary electrode pairs 120, 125 a power supply 130, and an agitator 140. Although only one primary electrode pair 120, 125 is illustrated in FIG. 1, the system may comprise a plurality of primary electrode pairs. The primary electrode pairs are positioned to be at least partially immersed in water 115 held in the reservoir 110. The primary electrode pairs are the electrode pairs used to perform the electrolysis process. The power supply 130 is adapted to power the one or more primary electrode pairs 120, 125 to perform at least a first electrolysis phase. During the first electrolysis phase an electrical current is passed between the one or more pair of primary electrodes in the contaminated water. One electrode will act as a cathode and the other an anode, depending on the polarity of the power supplied to the pair. During the first electrolysis phase one or more of the primary electrode pairs 120, 125 are powered using an electrical current of a first polarity such that for each powered primary electrode pair one electrode provides dissolved ions which act as an attractant for impurities to aid removal of the impurities from the water. Ion generation can occur at voltages of around 1.7 volts. However, in practice typically voltages of around 4 volts or more are used. During electrolysis oxygen and hydrogen are also generated forming small bubbles also referred to as micro-bubbles which help float the captured contaminants to the surface of the water for removal. The majority of the micro-bubbles are generated from the cathode.

The agitator 140 is operable to cause movement in the water and particles and gases therein to aid carriage of ions and impurities away from the electrodes. This agitation advantageously reduces the amount of clogging of the electrodes and can even provide a cleaning effect. Movement of the water can have a further advantage of enhancing the efficacy of the coagulation through mixing of the coagulants and contaminants.

The materials for the electrodes are chosen such that the anode for the first electrolysis phase is a sacrificial electrode adapted to erode as it releases positive ions into the water during the electrolysis process. Electrodes are typically formed from metal plates supported by a frame and electrically connected to a power supply. The active components of the treatment process are positive ions generated from the electrode acting as the anode during the first electrolysis phase. These positive ions are the coagulating agent for the impurities. Coagulation of the impurities facilitates removal of these from the water. The type of material chosen for the anode can be based on the anticipated impurities and contaminants in the water. For example, some known systems the materials used to form anode plates are aluminium and iron. These replicate the actions of the chemical flocculants aluminium sulphate and ferric chloride. Copper anodes may also be used to generate copper ions to destroy algae.

A known problem in electroflocculation and electro-coagulation systems is the electrodes becoming fouled, usually termed clogging, and cease to pass current. A known method to attempt to reduce clogging of the electrodes is to provide a second electrolysis phase where the polarity of the electrodes is reversed. The desired result is that this polarity reversal will cause material that has attached to the electrode plates during the first electrolysis phase to be repelled from the plates by the change in charge during the second electrolysis phase. In some cases the polarity reversal does cause some of the material to be pushed away from the electrodes. However, this is dependent on the types of electrodes and the types of impurities in the water. For example, where the contaminants in the water include noticeable quantities of fats, oils and greases (FOGs), changing polarity of the electrodes can reduce the electrode clogging. However, it has been observed that different materials behave differently and in some circumstances reversal of polarity produces no cleaning effect.

Further, the efficacy of polarity reversal for reducing electrode clogging can also be dependent on the types of electrodes used. For example, some systems have sacrificial anodes made of materials such as iron or aluminium, and what are termed non-reactive or non-eroding cathodes made of material such as stainless steel and titanium. Titanium makes an ideal cathode, but when used as an anode the titanium quickly oxidises and current will cease to flow. However, when switched back to being a cathode the oxidation is reversed and current begins to flow again and the process resumes. The problem is that in the case where titanium cathodes are used, reversal of polarity cannot be guaranteed to provide a cleaning effect due to the oxidation of the titanium anode. This can be mitigated somewhat by electroplating other materials onto the titanium, known as titanium multi-metal oxides (MMO) and titanium dimensionally stabilised anodes (DSA). Although polarity reversal can reduce electrode clogging in some circumstances, the electrodes still typically become too fouled to be effective before the sacrificial material of the anode has been fully utilised.

Embodiments of the present invention provide an agitator adapted to cause movement of water, particles and gasses therein to aid carriage of ions and impurities away from the electrodes. An advantage of this movement is that the likelihood of the coagulated impurities adhering to and fouling the electrodes is reduced. In some cases the agitator can also provide a cleaning effect, reducing fouling of the electrodes. The agitator can be any mechanism for causing movement. The agitator may include more than one mechanism for causing agitation of the water and particles and gases therein.

In an embodiment the agitator works to move water within the reservoir. The water movement across the electrodes dislodges material from the electrodes to reduce clogging. For example, the agitator may be a pump or stirring mechanism. The agitator can be adapted to cause the water to circulate between the plates during the first electrolysis phase to reduce the likelihood of material adhering to the electrodes. Where a second electrolysis phase is performed where the polarity of the electrodes is reversed, the agitator may also be operated during this second phase to aid removal of material form the electrodes. The agitator may be operated for a period of time after the electrolysis has ended to further reduce the likelihood of material being deposited on the electrodes before ceasing operation for a resting period where the coagulated impurities are allowed to settle or rise to the surface of the water for removal. A resting period may not be required where the coagulated impurities are removed through filtering. The agitator may be operated continuously or periodically during these phases and the amount of water movement caused may vary based on the phase. For example, the agitator may be operated to cause faster movement of water over the electrodes during the first or second electrolysis phase. The speed of the water movement for each electrolysis phase may be chosen based on the nature of the chemical reactions anticipated to occur during that phase. For example, the chemical reactions and therefore water movement requirements may change based on the contaminants in the water and the types of materials used for the electrodes.

In an alternative embodiment, the agitator injects a gas into the reservoir. For example, the agitator may inject the gas into the reservoir from below the electrodes to cause a plurality of bubbles to rise up through the water and aid movement of the water through the electrode plates. For example, air can be injected into the reservoir through air stones, fine mesh or perforated tubes, the effect being air is dispersed throughout the bottom of the reservoir as fine bubbles which then rise up through the water. The movement of bubbles over the plates can provide a mechanical cleaning effect, dislodging material deposited on the plates, as well as reducing the tendency of material to adhere to the electrodes. In an embodiment the agitator includes a plurality of perforated pipes disposed within the reservoir below the primary electrode pairs through which the gas in injected. In some embodiments the gas injected into the reservoir is air. In some alternative embodiments the air may be passed through an ozone generator before being injected into the reservoir. This provides a gas having a significant proportion of ozone which can provide sterilization effects.

In a further alternative embodiment the agitator comprises one or more sets of secondary electrodes disposed below the primary electrode pairs and connected to a power supply whereby power provided to the secondary electrodes causes production of bubbles within the water. The secondary electrodes can be non-eroding electrodes which produce small bubbles, also referred to as micro-bubbles, when powered. These micro-bubbles pass through the primary electrode pairs above them to help remove coagulated material from the primary electrode plates. The bubbles result from water in the region around the electrodes changing to a gaseous state. Some bubbles can result from the electric current applied to the secondary electrodes causing decomposition of water (H₂O) molecules into oxygen (O₂) molecules and hydrogen (H₂) molecules which take a gaseous form. Bubbles can also result from ions being generated at the electrodes from the electric charge causing breakdown of water molecules (H₂O) into ions, for example (OH)− and H+ ions. Another cause of bubbles can be localised heating of the water causing it to boil and become gaseous. The type of contaminants in the water being treated can also influence the electrolytic chemical reactions occurring in the region of the secondary electrodes. For example, contaminants affecting the acidity of the water may affect the electrolytic reactions occurring in the region f the secondary electrodes. The mix of gases causing the bubbles can vary between embodiments and even between batched of water being treated. For example, the gases may vary depending on the acidity of the water, current applied and contaminant load in the water. In some instances powering of the secondary electrodes may also cause electrolytic reactions in contaminants which may contribute to the gaseous mixture of the bubbles.

The micro-bubbles can, in some circumstances, also act to free material deposited on the plates of the primary electrode set in a manner similar to that produced when polarity of the primary electrode set is reversed by reducing or neutralizing the affect of electrostatic charge build-up resulting form the generation of positive ions from the anodes. For example, where the pH of the water is greater than 7 the secondary electrode sets generate (OH)− hydroxyl ions from the cathodes and H+ hydrogen ions from the anodes. Thus, these ions can reduce the affect of electrostatic charge. These ions, in particular the hydroxyl ions, can also have a sterilizing effect as the hydroxyl ions are more reactive than ozone. Further chlorine can be produced from the reaction between the electrons that provide the electric current through the water and sodium chloride molecules in the water.

Use of these secondary electrodes can alleviate the need for a second electrolysis phase where the polarity of the primary electrodes is reversed. The constant stream of micro-bubbles produced by the secondary electrodes inhibits build up of material on both the anode and cathode plates of the primary electrodes. Use of the secondary electrodes can also be advantageous for treatment of water having significant calcium hardness.

In some embodiments more than one agitator may be provided. Depending on the nature of the impurities and contaminants or the load of the contaminants in the water, the secondary set of electrodes only may not be sufficient to inhibit clogging of the electrodes. For example, heavier contaminant particles are less likely to move away from the anode after capture by the coagulating ions. Further, some contaminants are more electrically attracted to the anode than others. In both circumstances reversing polarity of the primary electrodes or relying on the secondary electrodes may not be sufficient. A system may be provided for such circumstances where more than one agitator is provided. For example, a system may be provided with both a set of secondary electrodes and a second agitator for causing circulation of water through the primary electrodes. For example, the second agitator may inject air into the reservoir using air stones or micro-perforated tubing. Alternatively the second agitator may circulate water through the electrode sets using a pump or stirring mechanism such as a mechanical stirring arm, propeller or impeller under the water. Thus, there is a mechanical effect of the bubbles and water movement removing any material that may build up on the primary electrodes. The combined effect of these two agitators can be sufficient to avoid fouling of the primary electrodes. Further, providing circulation of the contaminants through the primary electrodes can improve the bonding of contaminant particles and coagulating ions because previously coagulated particles are moved away from the anodes.

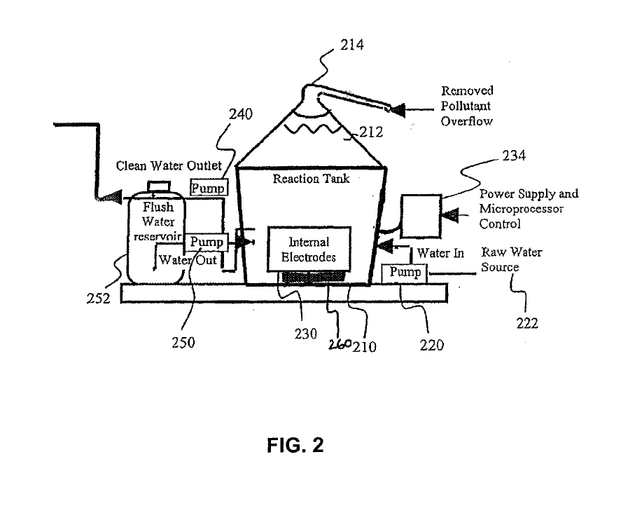

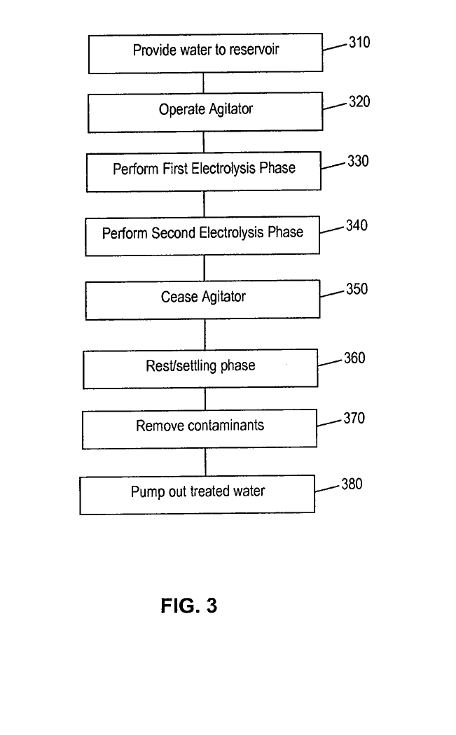

A method and system for performing electroflocculation and electrocoagulation will now be described in more detail with reference to FIGS. 2 and 3. The water to be treated is provided 310 to the treatment system 200 from a raw water source 222. The raw water is pumped from the raw water source 222 into the treatment reservoir 210 using a pump 220. The reservoir 210 can be shaped to have a relatively deep cone section (not shown) for performing batch treatment processing. Some heavily contaminated waters coagulate rather than flocculate or can do both. During the treatment process the coagulated material will sink to the bottom of the reservoir and collect in the cone shaped section in the base of the reservoir for removal. The top of the reservoir narrows to a floc chute 214 for removal of flocculated contaminates which rise to the surface of the water.

Primary electrodes 230 are provided within the reservoir 210 and are electrically connected to a power supply 234. The primary electrodes 230 are positioned to be at least partially immersed in the water to be treated. The illustrated embodiment includes a plurality of primary electrode pairs which can be selected for use during the electrolysis process. This selection can be controlled by a controller, for example implemented as a microprocessor executing a program for controlling the electrolysis process. The selected electrode pairs are driven using the power supply 234 to perform the electrolysis. An agitator 260 is also provided within the reservoir. Where the agitator 260 is a set of secondary electrodes, these may also be connected to the power supply 234 for selection and driving under microprocessor control. Where the agitator is a mechanical stirring device, pump, air compressor etc this may also be connected to an alternative power supply or drive mechanism also under microprocessor control.

After raw water is pumped into the reservoir 310, the agitator 260 is operated 320 and power applied to the primary electrodes 230 selected for the first electrolysis phase 330. Selection of electrodes may be based on the type of electrode and treatment sequence. Alternatively, the selection of electrodes may be based on the amount and level of contamination of the water and calculated current requirements for the water treatment. Where not all primary electrode pairs are required to be activated for an electrolysis phase, the microprocessor may be programmed to select the electrode pairs activated based on cumulative use relative to other electrode pairs. For example, if not all primary electrode pairs are required to pass the maximum current from the power supply the controller may determine which electrodes have passed the least cumulative total current and select these first. In this way use of the electrodes can be evened out, aiming to maximize the effective life of each anode. Depending on the embodiment more than one power supply may be provided with separate power supplies being used to drive one or more electrode pairs. The power supplies may be controlled such that the maximum current and hence maximum coagulation of the contaminants occurs at the beginning of the electrolysis phase. The power can then be reduced by switching of one or more power supplies toward the end of the electrolysis phase to reduce the current and hence disturbance of the floc.

The controller also controls operation of the agitator to cause movement of water and any particles and gases therein over the electrodes to aid carriage of ions and impurities away from the electrodes. For example, the agitator may be operated periodically or “pulsed” in some systems. Alternatively the agitator may be operated continuously. The amount of agitation caused can also be controlled. For example, where the agitator is in the form of an underwater propeller or fan the rotation speed of the blades may be slowed down or sped up to reduce or increase the amount of agitation. The amount of agitation can be controlled based on the phase of the electrolysis process. The agitator continues or ceases operation also under control of the controller.

The controller can use several methods to determine when to end the first phase. For example, the cumulative charge applied during the first phase to power the electrode pairs can be monitored by the controller. The controller can then end the first phase 330 by ceasing to power the primary electrodes when a cumulative charge threshold based on volume of water treated and the contaminant load in the water is reached. In another example, the controller can measure the current flow for a short period of time, say 5 seconds, at the start of the electrolysis phase. Based on the measured current the controller can calculate the required duration for the first phase based on the measured current, volume of water and contaminant load. The controller can then set a time for ending the first phase. It should be appreciated that the time for measuring the initial current flow may vary between embodiments. The current flow may also be periodically measured during the electrolysis phase and the duration of the phase adjusted accordingly, if necessary, to compensate for any current fluctuations. It will be appreciated that this will not be necessary where a current regulating power supply is used. Alternatively, where the power supply is not regulated but may be manually adjusted, periodic measurements of current may be taken and the voltage of the power supply adjusted in response to changes to maintain a substantially constant current flow throughout the first phase.

Typically the controller will continue to operate the agitator for at least a short period of time after the end of the first electrolysis phase to clean the primary electrodes.

An optional second electrolysis phase, where the polarity of the primary electrodes is reversed, may be executed 340. For example, where there are noticeable quantities of fats oils and greases (FOGs) in the water the second electrolysis phase may be advantageous. For example, in a system using iron cathode plates for the first electrolysis phase, reversal of polarity causes the iron plates to become anodes releasing ferric ions to capture the FOGs. Operation of the agitator is typically continued through this optional second electrolysis phase. Similarly as above for the first phase the controller can measure the current to determine the appropriate duration for the second phase based on the volume of water and contaminant load.

The first and second electrolysis phases, where the polarity reversal is used, may be executed more than once each, depending on the nature of the contaminants in the water. Once the electrolysis phases are completed the controller controls ceasing operation 350 of the agitator 260. Ceasing 350 agitator operation may be delayed for a period of time after completion of electrolysis in order to clean the primary electrodes. The process may include a resting phase 360 wherein the coagulated contaminants are allowed to settle or accumulate on the surface of the water for removal 370. In a system where the contaminants are removed by filtering the resting step may be omitted.

The reservoir 210 illustrated includes a floc chute 214 connected at the top of the reservoir for removal of pollutants from the surface of the treated water 212. The floc chute 214 follows the slope of the reservoir 210, for example angled around 45° down from the horizontal. The floc chute 214 sits atop a riser section and the join between the two is a straight section. Thus the riser starts from the bottom up as a circular section on top of the reservoir cone and changes to a straight horizontal section. The straight section and the angle of the floc chute 214 aid in drawing the floc down into the chute. The flocculated material will rise to the surface of the water, additional water can be pumped into the reservoir form the flush water reservoir 252 using pump 250 is necessary to raise the surface of the water to the lip of the riser to the floc chute 214.

The treated water is pumped 380 out of the reservoir 210 using pump 240 through a port above the level of the cone section where coagulated contaminants collect. The material at the base of the reservoir can then be drained. Alternatively the coagulated contaminants may be drained before pumping the treated water from the reservoir. The reservoir can be periodically flushed out by pumping water from a flush water reservoir 252 using pump 250 into the treatment reservoir 210.

In some embodiments the agitator alleviates the need for reversal of electrodes for cleaning purposes. In such embodiments it therefore becomes possible to implement a system where the cathode for the electrolysis can be the vessel holding the water to be treated. In such a system the vessel is connected to a power supply to act as a cathode and the sacrificial anodes are provided within the vessel. This can further reduce the cost of implementing the system.

Providing an agitator adapted to cause movement in the water and particles and gases therein to aid carriage of ions and impurities away from the electrodes has a significant advantage in reducing fouling of electrodes in an electrolysis based water treatment system. This, in turn, can significantly reduce the operation and maintenance costs for such systems. Further, the agitator can improve the efficacy of these systems.

It should be appreciated that agitators may also be installed in existing electrolysis based water treatment systems to achieve the advantages described above.

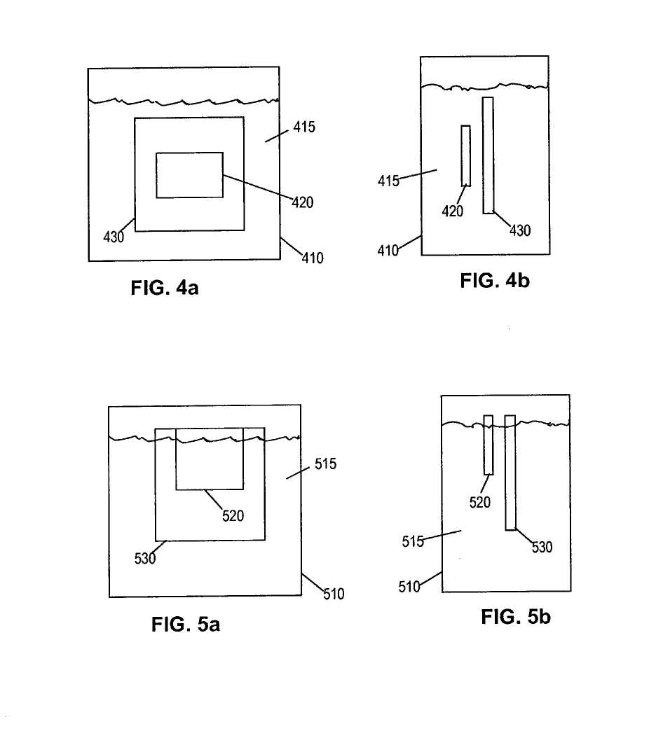

Some advantageous electrode cleaning effects can also be obtained based on the relative size and position of cathode and anode electrodes. Where the anode is smaller than the cathode the effects of clogging are reduced compared to where the anode and cathode have the same surface area. FIGS. 4a-b and 5a-b illustrate relative anode and cathode placement to improve cleaning effects.

FIGS. 4a and 4b show a front and side view of an electrode pair having a cathode 430 which is relatively larger than the anode 420, within a tank 410 of treated water 415. In this case the anode 420 and cathode 430 are each wholly submerged in the water 415. In this embodiment the anode 420 should be centred relative to the cathode 430 to achieve an improved cleaning effect.

FIGS. 5a and 5b show a front and side view of an electrode pair having a cathode 530 which is relatively larger than the anode 520, within a tank 510 of treated water 515. In this case the anode 520 and cathode 530 are only partly immersed in the water 515. In this embodiment the anode 520 should be centred relative to the cathode 530 in one axis to achieve an improved cleaning effect. For example as shown the anode 520 is aligned with and centred along the top edge of the cathode 530.

A preferred option is that the anode plates are reduced in size by a ratio equal to the spacing between the anode and cathode plates. However, the invention is not limited to that ratio because any lesser or greater difference in size will have a beneficial effect.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

1. A water treatment method comprising the steps of:
providing water to be treated to a treatment apparatus comprising:
a reservoir for holding the water to be treated;
one or more primary electrode pairs positioned to be at least partially immersed in water held in the reservoir and connected to a power supply; and
a selectively operable agitator;
performing a first electrolysis phase wherein one or more of the primary electrode pairs are powered using an electrical current of a first polarity such that for each powered primary electrode pair one electrode provides dissolved ions which act as an attractant for impurities to aid removal of the Impurities from the water;
operating the agitator during the first electrolysis phase to cause movement in the water and particles and gases therein to aid carriage of ions and impurities away from the electrodes; and
removing the impurities from the water.

2. A method as claimed in claim 1 wherein the agitator is operated periodically during the first electrolysis phase.

3. A method as claimed in claim 1 wherein the agitator works to move water within the reservoir.

4. A method as claimed in claim 3 wherein the agitator is a pump.

5. A method as claimed in claim 3 wherein the agitator is a stirring mechanism.

6. A method as claimed in claim 1 wherein the agitator injects a gas into the reservoir.

7. A method as claimed in claim 6 wherein the agitator injects the gas into the reservoir from below the electrode pairs as a plurality of bubbles.

8. A method as claimed in claim 6 wherein the gas is air.

9. A method as claimed in claim 6 wherein the gas includes a proportion of ozone.

10. A method as claimed in claim 1 wherein the agitator comprises one or more sets of secondary electrodes disposed below the primary electrode pairs and connected to a power supply whereby power supplied to the secondary electrodes causes production of bubbles within the water.

11. A method as claimed in claim 1 further comprising the steps of
performing a second electrolysis phase during which one or more pairs of electrodes are powered using an electrical current having a reverse polarity to that of the first polarity; and
operating the agitator during the second electrolysis phase.

12. A method as claimed in claim 1 wherein the agitator is operated during a resting phase after the completion of the electrolysis phase.

13. A water treatment system comprising
a reservoir for holding the water to be treated;
one or more primary electrode pairs positioned to be at least partially immersed in water held in the reservoir;
a power supply adapted to power the one or more primary electrode pairs to perform at least a first electrolysis phase wherein one or more of the primary electrode pairs are powered using an electrical current of a first polarity such that for each powered primary electrode pair one electrode provides dissolved ions which act as an attractant for impurities to aid removal of the impurities form the water; and
an agitator operable to cause movement in the water and particles and gases therein to aid carriage of ions and impurities away from the electrodes.

14. A system as claimed in claim 13 further comprising an agitator controller adapted to control operation of the agitator based on electrolysis phase.

15. A system as claimed in claim 13 wherein the agitator works to move water within the reservoir.

16-23. (canceled)

24. A system as claimed in claim 13 wherein the agitator comprises one or more sets of secondary electrodes disposed below the primary electrode pairs and connected to a power supply whereby power supplied to the secondary electrodes causes production of bubbles within the water.

25. A system as claimed in claim 13 wherein the power supply is further adapted to power one or more pairs of electrodes during a second electrolysis phase using an electrical current having a reverse polarity to that of the first polarity.

26. A method of upgrading an electrolysis-based water treatment system comprising:
a reservoir for holding the water to be purified;
one or more primary electrode pairs positioned to be at least partially immersed in water held in the reservoir; and
a power supply adapted to power the one or more primary electrode pairs to perform at least a first electrolysis phase wherein one or more of the primary electrode pairs are powered using an electrical current of a first polarity such that for each powered primary electrode pair one electrode provides dissolved ions which act as an attractant for impurities to aid removal of the impurities form the water,
the method comprising the step of:
installing an agitator operable to cause movement in the water and particles and gases therein to aid carriage of ions and impurities away from the electrodes.
